(19) United States
(12) Patent Application Publication
(10) Pub. No.: US 2004/0226783 A1
(43) Pub. Date: Nov. 18, 2004

(54) Piston boot/guide for a caliper brake system

(75) Inventors: Andrew F. Hall, Dayton, OH (US); Schuyler S. Shaw, Dayton, OH (US); John A. Hart, Middletown, OH (US); Shawn C. Guffey, Germantown, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/439,522

(22) Filed: May 16, 2003

(51) Int. Cl. F16D 55/18

(52) U.S. Cl. 188/72.4

(57) ABSTRACT

The present invention provides an improved boot guide for a caliper brake system. The improved boot guide includes a guide portion integrally formed with a boot portion, wherein the guide portion guides a brake piston and the boot portion seals the brake piston. The piston may be electrically driven. Alternatively, the piston may be hydraulically driven. The guide portion of the single piece boot guide may further include a radial support member that provides a radial retaining force. The radial support member may be manufactured utilizing material selected from a group consisting of mild steel and spring steel. The single piece boot guide may be manufactured from an elastomer. The elastomer may be selected from the group consisting of polyvinyl chloride, ethylene propylene terpolymer rubber, and nitrile rubber. The boot portion may form convolutions within a boot guide cavity. The guide portion may include an environmental seal portion.

### FIELD OF THE INVENTION

The technical field of this disclosure is brake systems, and more particularly, caliper brake system boot assemblies with improved performance.

### BACKGROUND OF THE INVENTION

Caliper brake systems are exposed to and require protection from numerous elements, such as, for example weather. Existing caliper brake systems typically are of hydraulic methodology and require a seal to contain the fluid within the system. Current methodology for protecting and sealing existing caliper brake systems generally requires an undesirable amount of machining, such as, for example the caliper housing.

Newer systems include electromechanical caliper brake systems. Some applications utilize a combination of the two systems, referred to as a hybrid brake system. For cost purposes, it is desirable to utilize as many of the same parts as possible between systems.

Electromechanical caliper brake systems do not have the same sealing requirements as those mandated by the use of hydraulic fluid. However, electromechanical caliper brake (ECB) systems still require protection from external elements. Additionally, ECB systems incur other challenges, such as, for example piston guidance within the ECB system piston cavity. Unfortunately, when the hydraulic system is removed from a hydraulic caliper brake system cavity and replaced with an ECB system, piston guidance is greatly degraded. Piston guidance is degraded as the same piston cavity is utilized for both systems. The degrading of the piston guidance, referred to as sloppy, is not acceptable.

It would be desirable, therefore, to provide a system that would overcome these and other disadvantages.

### SUMMARY OF THE INVENTION

One aspect of the present invention provides a brake system assembly including a caliper housing having a boot guide cavity and a piston moveable within the caliper housing. The brake system assembly further includes a single piece boot guide having a guide portion with a guide end and a boot portion with a boot end. The guide end is positioned within the boot guide cavity and the boot end is connected to the piston.

Another aspect of the present invention provides a single piece boot guide including a guide portion integrally formed with a boot portion. The guide portion guides a brake piston and the boot portion seals the brake piston.

According to yet another aspect of the present invention, a brake system assembly is provided. The brake system assembly includes a caliper housing including a cavity. The brake system assembly further includes a piston moveable within the caliper housing. Means for guiding and sealing the piston positioned in the cavity are also provided.

The foregoing and other features and advantages of the invention will become further apparent from the following detailed description of the presently preferred embodiment, read in conjunction with the accompanying drawings. The scope of the invention is defined by the appended claims and equivalents thereof, the detailed description and drawings being merely illustrative of the invention rather than limiting the invention.

### BRIEF DESCRIPTION OF THE DRAWINGS

FIG. 1 is a cross sectional view illustrating a brake system assembly according to an embodiment of the present invention;

FIG. 2 is a perspective diagram illustrating a boot guide device in free form according to an embodiment of the present invention;

FIG. 3A is an cross sectional view illustrating a contracted boot guide device, in use, according to another embodiment of the present invention; and

FIG. 3B is a cross sectional view illustrating an extended boot guide device, in use, according to yet another embodiment of the present invention.

FIG. 4 is a cross sectional view illustrating an extended boot guide device, in use, according to another embodiment of the present invention.

Throughout the specification, and in the claims, the term “connected” means a direct connection between components or devices that are connected without any intermediate devices. The term “coupled” means either a direct connection between components or devices that are connected, or an indirect connection through one or more passive or active intermediary devices.

### DETAILED DESCRIPTION OF THE PRESENTLY PREFERRED EMBODIMENT

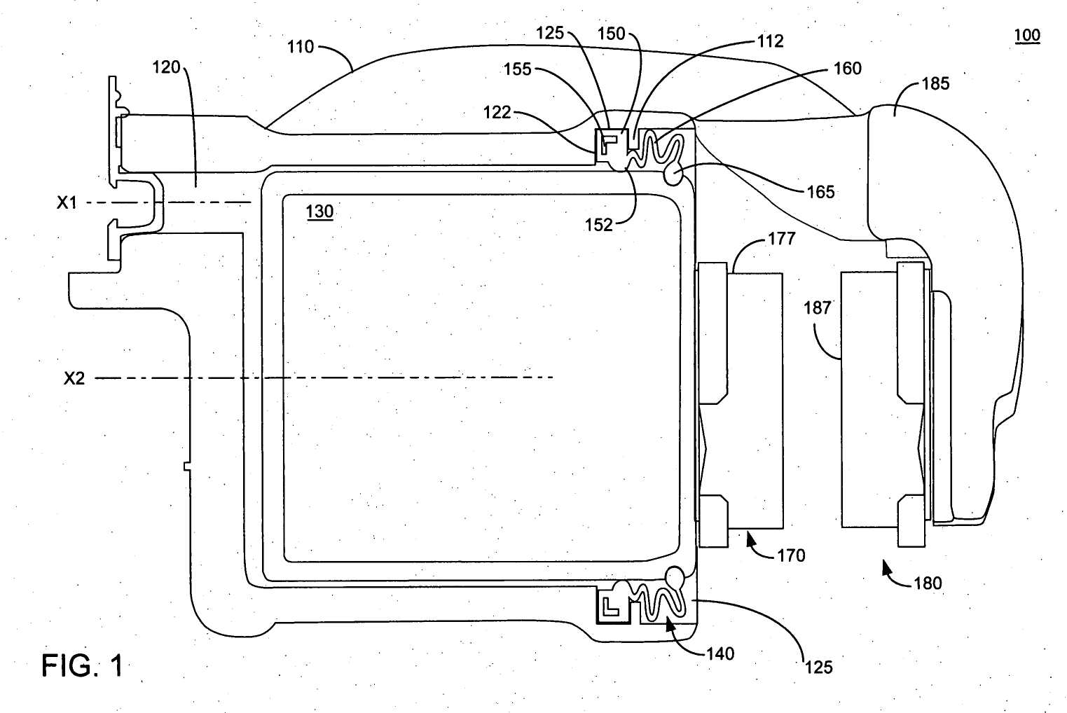

FIG. 1 is a cross sectional view illustrating a brake system assembly that is in accordance with the present invention. FIG. 1 details an embodiment of an apparatus for providing braking force to a wheel assembly (not shown) in accordance with the present invention and may be referred to as brake assembly 100. In one embodiment and referring to FIG. 1, brake assembly 100 is implemented within an automobile disc brake system.

In FIG. 1, brake assembly 100 includes caliper housing 110 having piston cavity 120 and boot-guide cavity 125. Brake assembly 100 additionally includes outboard flange 185 and caliper assemblies (170 and 180). Caliper assembly 180 is coupled to outboard flange 185. Brake assembly 100 further includes piston 130 moveable within piston cavity 120, also referred to as a caliper bore, and single-piece boot guide 140 within boot guide cavity 125. In one embodiment, piston 130 is hydraulically driven.

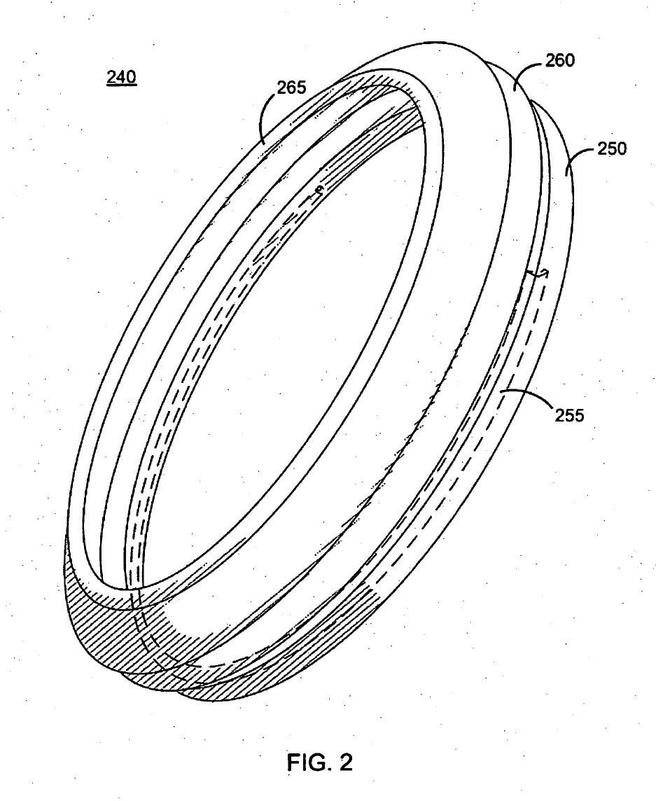

Single-piece boot guide 140, detailed in FIG. 2 below, includes guide portion 150 and boot portion 160. Guide portion 150 includes back-up seal 152 portion positioned within boot-guide cavity 125 and may include an optional radial support member 155. Boot portion 160 includes boot end 165 coupled to piston 130.

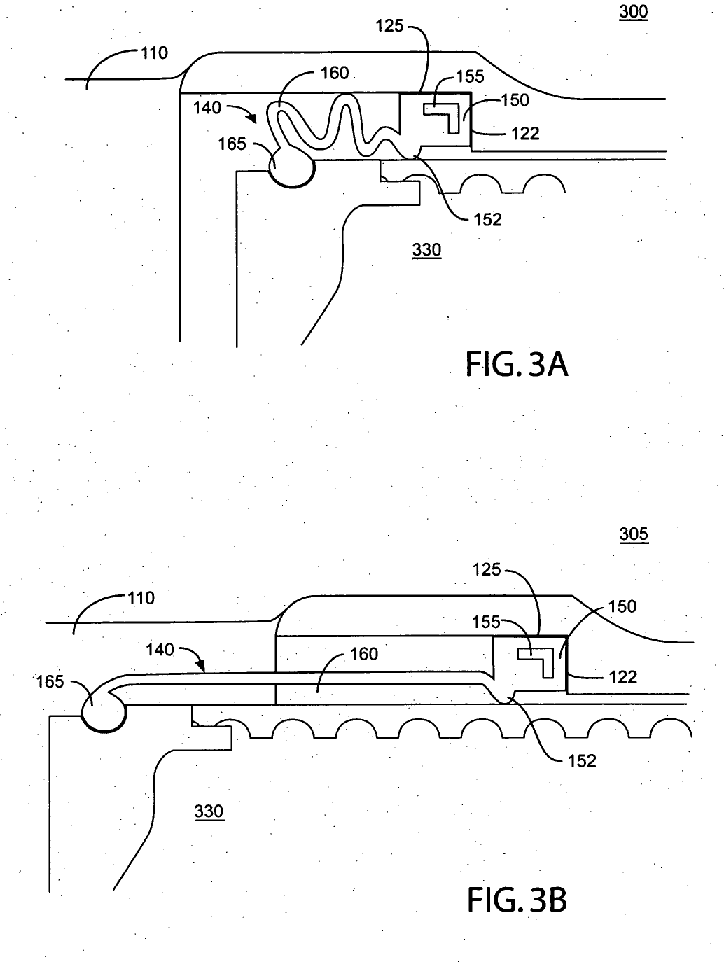

Boot-guide cavity 125 is defined by cavity base 122, cavity wall 125, and a respective side of piston 130. Boot-guide cavity 125 is designed to accommodate guide portion 150 of single-piece boot guide 140, and boot portion 160 of single-piece boot guide 140. In one embodiment, boot-guide cavity 125 is implemented as a counter bore within caliper housing 110. In an example, boot-guide cavity 125 is implemented as a counter bore further including an under cut portion 112. In another example, boot-guide cavity 125 is implemented as a counter bore without including the cut portion (see FIGS. 3A and 3B).

Back-up seal 152 portion of guide portion 150 of single-piece boot guide 140 is retained within boot-guide cavity 125 by cavity base 122, cavity wall 125, and the respective side of piston 130. Back-up seal 152 portion of guide portion 150 provides guidance to piston 130 during activation to assure proper movement of piston 130 within piston cavity 120.

In another embodiment, guide portion 150 is retained within under cut portion 112 of caliper housing 110 in addition to boot-guide cavity 125. In an example, guide portion 150 is retained within boot-guide cavity 125 due to under cut portion 112 as well as inherent outward radial forces within guide portion 150. In this example, back-up seal 152 portion of guide portion 150 provides sealing as well. This configuration is well suited for use in hydraulic applications.

Because guide portion 150 is retained within boot-guide cavity 125 and boot end 165 of boot portion 160 is coupled to piston 130, single-piece boot guide 140 assumes different forms as piston 130 extends and contracts within piston cavity 120.

Boot portion 160 of single-piece boot guide 140 forms convolutions within boot-guide cavity 125 when piston 130 is contracted, as detailed in FIGS. 1 and 3A. In one embodiment, boot portion 160 of single-piece boot guide 140 is manufactured so that it is predisposed to form the convolutions.

Alternatively and detailed in FIG. 3B below, boot portion 160 of single-piece boot guide 140 extends to accommodate piston movement when piston 130 is extended, as detailed in FIG. 3B. In one embodiment, boot portion 160 of single-piece boot guide 140 is manufactured so that it has a length to accommodate piston 130 movement. Boot portion 160 of single-piece boot guide 140 provides protection of the piston 130 and the piston cavity 120.

Single-piece boot guide 140 can be manufactured from any suitable material, such as, for example an elastomer including any of the members of the polymer family. Such polymers include, but are not limited to, polyvinyl chloride, ethylene propylene terpolymer rubber, and nitrile rubber.

Radial support member 155 can be manufactured from any suitable material supplying rigid or semi-rigid material characteristics. In an example, radial support member 155 is manufactured from mild steel. In another example, radial support member 155 is manufactured from spring steel.

In operation, force is applied to piston 130 along an axis defined as x1-axis. In an example, force is applied to piston 130, along the x1-axis, utilizing an electromechanical methodology. In another example, force is applied to piston 130, along the x1-axis, utilizing a hydraulic methodology.

Force applied along the x1-axis is translated into a force applied to piston 130. The force applied to piston 130 causes piston 130 to travel along an axis defined as x2-axis. The travel of piston 130 along the x2-axis results in a force applied to caliper assembly 170 along the x2-axis and is applied to caliper 177. The force applied to caliper 177 is in the direction of piston travel.

Simultaneously, a force (not shown) is applied to outboard flange 185 of caliper assembly 180. Due to the mechanics of outboard flange 185, the force applied is translated into an inward force applied to caliper 177 along the x2-axis. The force applied to caliper 187 is in the direction opposite piston travel. A combination of the forces, applied in opposite directions along the x2-axis, result in force applied to a rotor (not shown).

FIG. 2 is a perspective diagram illustrating a boot guide device in free form according to an embodiment of the present invention. Single-piece boot guide 240 includes guide portion 250 and boot portion 260. Guide portion 250 may include an optional radial support member 255. Boot portion 260 includes boot end 265. Like components from FIGS. 1 and 2 are labeled similarly and named and function identically.

Referring to FIG. 2, boot portion 260 further includes convolutions that allow boot portion 260 to fold upon itself when contracting. In one embodiment, boot portion 260 is predisposed to form the convolutions. In an example, boot portion 260 is manufactured, to include the convolutions, from a material that allows or enhances the formation of the convolutions, for example an elastomer described in FIG. 1 above. In another embodiment, convolutions form when boot portion 260 contracts without manufacturing assistance, such as, for example due to material utilized in the manufacture of boot portion 260.

FIGS. 3A and 3B are cross sectional views illustrating a boot guide device, in use, according to an embodiment of the present invention. Like components from FIGS. 1-3 are labeled and named similarly, and function identically. In one embodiment, piston 330 is electromechanically driven.

FIG. 3A illustrates a contracted boot guide device 300, in use, according to an embodiment of the present invention. FIG. 3B illustrates an extended boot guide device 305, in use, according to an embodiment of the present invention. In one embodiment, piston 330 is electromechanically driven.

In one embodiment, guide portion 150 is retained within boot-guide cavity 125 utilizing a press-fit methodology in, for example, electromechanical applications. In an example, guide portion 150 is press-fitted within boot-guide cavity 125 and retained due to inherent outward radial force within guide portion 150. In this example, guide portion 150 may include optional redial support member 155 that provides additional outward radial force to guide portion 150.

In FIGS. 3A and 3B, guide portion 150 is retained within boot-guide cavity 125 and boot end 165 of boot portion 160 is coupled to piston 130. In operation, single-piece boot guide 140 assumes different forms as piston 130 contracts (FIG. 3A) and extends (FIG. 3B) within piston cavity 120.

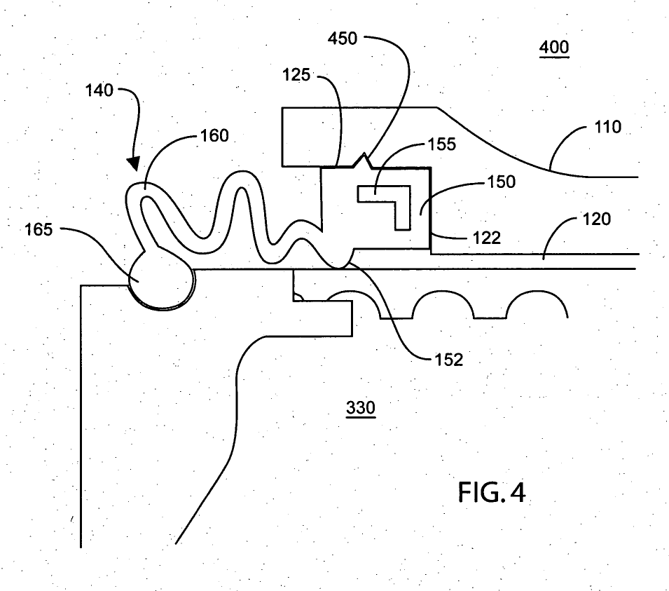

FIG. 4 is a cross sectional view illustrating an extended boot guide device, in use, according to another embodiment of the present invention. Like components from FIGS. 1-4 are labeled and named similarly, and function identically.

FIG. 4 illustrates a contracted boot guide device 400, in use, according to an embodiment of the present invention. Boot guide device 400 further includes v-cut 450 within caliper housing 110. In one embodiment, v-cut 450 is implemented as a counter bore within caliper housing 110. A portion of guide portion 150 migrates into an area provided by v-cut 450. The migration results from outward radial force inherent within guide portion 150. The migrated portion of guide portion 150 provides added stability to single-piece boot guide 140 by increasing retention of single-piece boot guide 140 within boot-guide cavity 125. Added stability to single-piece boot guide 140 increases robustness of boot guide device 400.

The above-described brake system boot assembly having a single-piece boot guide is an example device. The brake system boot assembly having a single-piece boot guide illustrates one possible approach for improving performance in a caliper brake system boot assembly. The actual implementation may vary from the package discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

1. A brake system assembly comprising:
a caliper housing, the caliper housing including a boot guide cavity, the boot guide cavity including a counter bore;
a piston moveable within the caliper housing; and
a single piece boot guide, the single piece boot guide having a guide portion with a guide end and a boor portion with a boot end, the guide end including a back-up seal portion;
wherein the guide end is positioned within the counter bore of the boot guide cavity and the boot end is operably coupled to the piston, the back-up seal portion of the guide end is positioned against the piston.

2. The brake system assembly of claim 1, wherein the guide portion of the single piece boot guide provides a seal to the piston.

3. (Cancelled).

4. The brake system assembly of claim 1, wherein the counter bore further comprises an under cut portion to accommodate the guide portion of the single piece boot guide.

5. The brake system assembly of claim 1, wherein the counter bore further comprises a v-cat counter bore opposite the piston, the v-cut counter bore designed to allow a portion of the guide portion to migrate within the v-cut counter bore.

6. The brake system assembly of claim 1, wherein the guide portion includes a radial support member, the radial support member providing a radial retaining force.

7. The brake system assembly of claim 6, wherein the radial support member providing the radial retaining force is selected from the group consisting of: rigid and semi-rigid.

8. The brake system assembly of claim 6, wherein the radial support member is manufactured utilizing material selected from a group consisting of: mild steel and spring steel.

9. The brake system assembly of claim 1, wherein the guide end is positioned within the boot guide cavity to provide guidance to the piston.

10. The brake system assembly of claim 1, wherein the boot portion has a length sized to accommodate piston movement.

11. The brake system assembly of claim 1, wherein the single piece boot guide is manufactured from an elastomer.

12. The brake system assembly of claim 11, wherein the elastomer is a polymer.

13. The brake system assembly of claim 1, wherein the single piece boot guide is manufactured from material from the group consisting of: polyvinyl chloride, ethylene propylene terpolymer rubber, and nitrile rubber.

14. The brake system assembly of claim 1, wherein the boot portion forms convolutions within the boot guide cavity.

15. The brake system assembly of claim 1, wherein the piston is electrically driven.

16. The brake system assembly of claim 1, wherein the piston is hydraulically driven.

17. The brake system assembly of claim 1, wherein the guide portion includes an environmental seal portion.

18. A single piece boot guide comprising:
a guide portion integrally formed with a boot portion, the guide portion including a back-up seal portion;
wherein the guide portion guides a brake piston, and the boot portion and the back-up seal portion seals the brake piston.

19. The single piece boot guide of claim 18, wherein the guide portion includes a radical support member, the radial support member providing a radial retaining force.

20. The single piece boot guide of claim 19, wherein the radial support member is manufactured utilizing material selected from a group consisting of: mild steel and spring steel.

21. The single piece boot guide of claim 18, wherein the single piece boot guide is manufactured from an elastomer.

22. The single piece boot guide of claim 21, wherein the elastomer is selected from the group consisting of polyvinyl chloride, ethylene propylene terpolymer rubber, and nitrile rubber.

23. The single piece boot guide of claim 18, wherein the guide portion includes an environmental seal portion.

24. A brake system assembly, the assembly comprising:
a caliper housing, the caliper housing including a cavity, the cavity including a counter bore;
a piston moveable within the caliper housing; and
means for guiding and sealing the piston positioned in the cavity;
wherein the guiding and sealing means are integrally formed; and
wherein the guiding means includes a guide end positioned within the counter bore of the cavity, the sealing means includes a boot end operably coupled to the piston, and the guide end of the guiding means includes a back-up seal portion positioned against the piston.
